(19) United States
(12) Patent Application Publication
(10) Pub. No.: US 2026/0019232 A1
(43) Pub. Date: Jan. 15, 2026

(54) COMMUNICATION METHOD FOR QUANTUM DIRECT COMMUNICATION AND QUANTUM DIRECT COMMUNICATION SYSTEM

(71) Applicants: BEIJING ACADEMY OF QUANTUM INFORMATION SCIENCES, Beijing (CN); TSINGHUA UNIVERSITY, Beijing (CN)

(72) Inventors: Guilu LONG, Beijing (CN); Dong PAN, Beijing (CN); Xiaotian SONG, Beijing (CN)

(73) Assignees: BEIJING ACADEMY OF QUANTUM INFORMATION SCIENCES, Beijing (CN); TSINGHUA UNIVERSITY, Beijing (CN)

(21) Appl. No.: 18/880,406

(22) PCT Filed: Feb. 6, 2024
(86) PCT No.: PCT/CN2024/076224

§ 371 Date: Dec. 31, 2024

(30) Foreign Application Priority Data
Mar. 10, 2023 (CN) 202310232212.1

(51) Int. Cl. H04L 9/06; H04L 9/08

(52) U.S. Cl. CPC H04L 9/0618; H04L 9/0852

(57) ABSTRACT

A communication method for quantum direct communication and quantum direct communication system, an electronic device and a non-transitory computer-readable storage medium. The quantum direct communication method is applied to a sender of the quantum secure direct communication system. The communication method includes: encrypting a transmitted message by using an encryption algorithm to obtain a ciphertext corresponding to the transmitted message; encoding the ciphertext into a quantum state through a quantum direct communication terminal of the sender according to a quantum communication protocol; and sending the quantum state to a receiver of the quantum direct communication system. According to some embodiments, by utilizing the encryption algorithm to encrypt the transmitted message, the capability of eavesdropper detection is provided for ciphertext transmission, reducing the risk of messages being intercepted by eavesdroppers. Meanwhile, the security of quantum direct communication systems constructed with non-ideal devices is strengthened.

### TECHNICAL FIELD

The application relates to the field of quantum direct communication, in particular to a communication method for quantum direct communication and quantum direct communication system, an electronic device and a computer-readable storage medium.

### BACKGROUND

Current quantum direct communication technology involves sending a plaintext message from a sender to a quantum direct communication terminal, which performs error correction coding and other operations on the plaintext message before transmitting it to a receiver in a quantum state.

Because the sender transmits plaintext information to the quantum direct communication terminal, and existing quantum direct communication systems are constructed with non-ideal devices, quantum hackers can exploit the features of these devices to launch attacks and steal confidential information during transmission, causing data leaks. For example, for quantum direct communication systems using avalanche photodiodes, an eavesdropper can implement a detector blinding attack to eavesdrop on the transmitted information.

### SUMMARY

The application aims to provide a communication method for quantum direct communication and communication system, an electronic device and a computer-readable storage medium to address potential security risks in practical information transmission using quantum direct communication systems and enhance their security.

According to an aspect of the application, a communication method for quantum direct communication is provided. The communication method is applied to a sender of a quantum direct communication system. The communication method comprises: encrypting a transmitted message by using an encryption algorithm to obtain a ciphertext corresponding to the transmitted message; encoding the ciphertext into a quantum state through a quantum direct communication terminal of the sender according to a quantum communication protocol; and sending the quantum state to a receiver of the quantum direct communication system.

According to some embodiments, the encryption algorithm comprises a symmetric cipher, an asymmetric cipher and/or a post-quantum cipher.

According to some embodiments, before encoding the ciphertext into a quantum state through a first quantum direct communication terminal according to a quantum communication protocol, the communication method further comprises: precoding the ciphertext to obtain a transmitted codeword corresponding to the transmitted message.

According to some embodiments, the precoding comprises error-correcting lossless coding, spread spectrum coding and/or secure coding.

According to some embodiments, encoding the ciphertext into a quantum state through a first quantum direct communication terminal according to a quantum communication protocol comprises: encoding the transmitted codeword corresponding to the ciphertext into the quantum state through the first quantum direct communication terminal according to the quantum communication protocol.

According to some embodiments, the quantum communication protocol comprises an entanglement protocol, a single photon protocol, a measurement device-independent protocol and/or a device-independent protocol.

According to an aspect of the application, a communication method for quantum direct communication is provided. The communication method is applied to a receiver of a quantum direct communication system. The communication method comprises: measuring a quantum state sent from a sender through a quantum direct communication terminal of the receiver to obtain a ciphertext corresponding to a transmitted message, the ciphertext being obtained by the sender encrypting the transmitted message by using an encryption algorithm; and performing decryption by using a decryption algorithm corresponding to the encryption algorithm to obtain the transmitted message.

According to some embodiments, measuring a quantum state sent from a sender through a quantum direct communication terminal of the receiver to obtain a ciphertext corresponding to a transmitted message comprises: measuring the quantum state sent from a sender by using the quantum direct communication terminal of the receiver to obtain a transmitted codeword corresponding to the ciphertext, the transmitted codeword being obtained by the sender precoding the ciphertext; and decoding and/or decrypting the transmitted codeword according to a rule corresponding to the precoding to obtain the ciphertext.

According to an aspect of the application, a quantum direct communication system is provided, comprising a sender and a receiver. The sender comprises: an encryption device configured toencrypt a transmitted message by using an encryption algorithm to obtain a ciphertext corresponding to the transmitted message; and a first quantum direct communication terminal of the sender configured to encode the ciphertext into a quantum state according to a quantum communication protocol and send the quantum state to the receiver of the quantum direct communication system; and
the receiver comprises: a second quantum direct communication terminal of the receiver configured to measure a quantum state sent from the sender to obtain a ciphertext corresponding to the transmitted message, the ciphertext being obtained by the sender encrypting the transmitted message by using an encryption algorithm; a decryption device configured to perform decryption by using a decryption algorithm corresponding to the encryption algorithm to obtain the transmitted message.

According to an aspect of the application, a quantum direct communication system is provided, comprising a first quantum direct communication terminal and a second quantum direct communication terminal; the first quantum direct communication terminal comprises an encryption module and a message sending module, the encryption module is configured to encrypt a transmitted message by using an encryption algorithm to obtain a ciphertext corresponding to the transmitted message, the message sending module is configured to encode the ciphertext into a quantum state according to a quantum communication protocol and send the quantum state to the second quantum direct communication terminal,

the second quantum direct communication terminal comprises a message receiving module and a decryption module, the message receiving module is configured to measure the quantum state sent from the first quantum direct communication terminal to obtain a ciphertext corresponding to the transmitted message, the ciphertext being obtained by the encryption module of the first quantum direct communication terminal encrypting the transmitted message by using the encryption algorithm, and the decryption module is configured to perform decryption by using a decryption algorithm corresponding to the encryption algorithm to obtain the transmitted message.

According to an aspect of the application, an electronic device is provided, comprising a memory and a processor. The memory stores one or more computer instructions, and the one or more computer instructions, when executed by the processor, implement the communication method according to any one of the above embodiments.

According to an aspect of the application, a computer-readable storage medium is provided, on which a computer program is stored, and when the computer program is executed, the communication method according to any one of the above embodiments is implemented.

According to some embodiments of the application, by utilizing the encryption algorithm to encrypt the transmitted message, the capability of eavesdropper detection is provided for ciphertext transmission, reducing the risk of messages being intercepted by eavesdroppers. Meanwhile, the security of quantum direct communication systems constructed with non-ideal devices is strengthened.

It should be understood that the above general description and the following detailed description are only exemplary, and do not limit the application.

### BRIEF DESCRIPTION OF THE DRAWINGS

In order to more clearly explain the technical schemes of the embodiments of the application, the drawings needed in the description of the embodiments are briefly set forth below. The above and other objects, features and advantages of the application will become more apparent by describing in detail exemplary embodiments with reference to the accompanying drawings.

FIG. 1 is a schematic diagram of a quantum direct communication system according to an exemplary embodiment of the application.

FIG. 2 is a flowchart of a quantum direct communication method according to an exemplary embodiment of the application.

FIG. 3 is a flowchart of a quantum direct communication method according to an exemplary embodiment of the application.

FIG. 4 is a communication timing diagram of quantum direct communication according to an exemplary embodiment of the application.

FIG. 5 is a block diagram of a quantum direct communication system according to an exemplary embodiment of the application.

FIG. 6 is a block diagram of another quantum direct communication system according to an exemplary embodiment of the application.

FIG. 7 is a schematic diagram of a quantum direct communication system according to an exemplary embodiment of the application.

FIG. 8 is a schematic diagram of another quantum direct communication system according to an exemplary embodiment of the application.

FIG. 9 shows an electronic device according to an exemplary embodiment of the application.

### DETAILED DESCRIPTION OF EMBODIMENTS

Exemplary embodiments will be described more fully below with reference to the accompanying drawings. However, the exemplary embodiments can be implemented in various forms and should not be construed as limited to the embodiments set forth herein. These embodiments are provided to make this application more thorough and complete, and to fully convey the concept of the exemplary embodiments to those skilled in the art. In the drawings, the same reference numerals refer to the same or similar parts, so repeated descriptions will be omitted.

The described features, structures, or characteristics may be combined in any suitable manner in one or more embodiments. In the following description, numerous specific details are provided to give a thorough understanding of the embodiments of the disclosure. However, those skilled in the art will realize that the technical solution of the disclosure can be practiced without one or more of these specific details, or other ways, components, materials, devices or operations can be adopted. In these cases, well-known structures, methods, devices, implementations, materials or operations will not be shown or described in detail.

The flowchart shown in the drawings is only an exemplary illustration, and does not necessarily include all contents and operations/steps, nor does it have to be executed in the described order. For example, some operations/steps can be decomposed, while others can be merged or partially merged, so the actual execution order may change according to the actual situation.

Terms such as “first” and “second” in the specification and Claims of this application and the drawings are used to distinguish different objects, but not to describe a specific order. Further, the terms “comprise” and “have” and any variations thereof are intended to cover non-exclusive inclusion. For example, a process, method, system, product or device comprising a series of steps or units is not limited to the listed steps or units, but optionally comprises steps or units not listed, or optionally comprises other steps or units inherent to the process, method, product or device.

Quantum communication refers to the technology of transmitting information using quantum states as carriers, providing a high level of security guaranteed by principles of quantum physics.

As quantum computing continues to develop, the security of classical cryptographic systems based on mathematically complex problems faces significant challenges. Consequently, quantum communication has gained widespread attention and is rapidly advancing, becoming a relatively mature section in the field of quantum information, and will play an important role in next-generation communication. Quantum communication technology is mainly divided into four branches: quantum key distribution (QKD), quantum direct communication (QSDC), quantum secret sharing, and quantum teleportation. Among these, entanglement-based quantum direct communication protocols and single-photon quantum direct communication schemes have been experimentally validated. With the advancement of product development and practical applications, real-time secure transmission of text, images, and audio files is now achievable.

Because a sender transmits plaintext information to a quantum direct communication terminal, and existing quantum direct communication systems are constructed with non-ideal devices, quantum hackers can exploit the features of these devices to launch attacks and steal confidential information during transmission, causing data leaks.

According to an embodiment of the application, before a receiver sends the transmitted message to the quantum direct communication terminal, the transmitted message is encrypted, thereby providing the capability of eavesdropper detection for ciphertext transmission, reducing the risk of messages being intercepted by eavesdroppers. Meanwhile, the security of quantum direct communication systems constructed with non-ideal devices is strengthened. Even if eavesdroppers exploit vulnerabilities in the actual devices to intercept the information transmitted by the quantum direct communication system, the eavesdroppers will only obtain ciphertext that is difficult to decrypt. Therefore, by utilizing the embodiment of the application, a higher level of secure communication can be established, accelerating the widespread application of quantum direct communication systems.

A method according to embodiments of the application will be described in detail below with reference to the attached drawings.

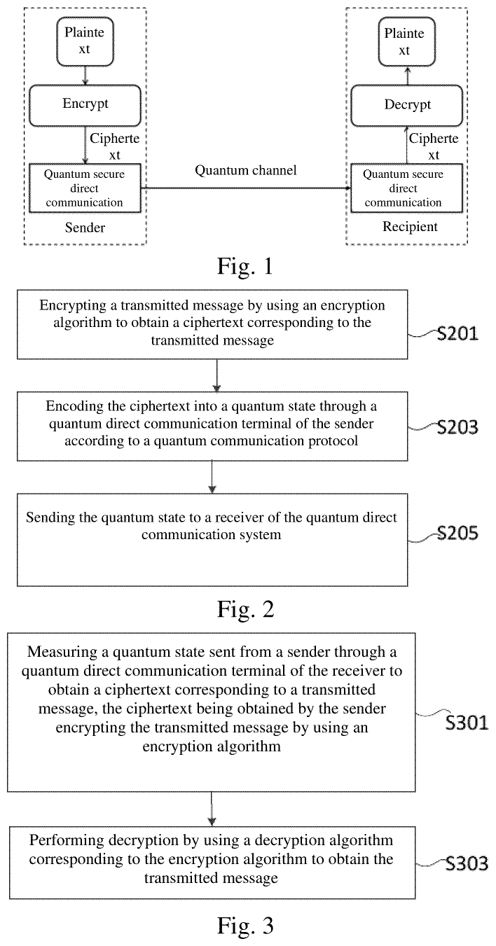

FIG. 1 is a schematic diagram of a quantum direct communication system according to an exemplary embodiment of the application. Hereinafter, with reference to FIG. 1, a quantum direct communication system according to an exemplary embodiment of the application will be described in detail.

As shown in FIG. 1, a plaintext of a transmitted message is encrypted by symmetric encryption, asymmetric encryption or post-quantum encryption algorithm, and a ciphertext corresponding to the transmitted message is obtained. The ciphertext of the transmitted message is sent to a quantum direct communication terminal of a sender, which precodes the ciphertext of the transmitted message through error-correcting lossless coding, spread spectrum coding and/or secure coding, and then the ciphertext of the transmitted message is sent to a quantum direct communication terminal of a receiver with a quantum state as the carrier. The quantum direct communication terminal of the receiver performs decoding and/or decryption according to a rule corresponding to the precoding to obtain the ciphertext corresponding to the transmitted message, and outputs the same. Then, the receiver decrypts the ciphertext according to a decryption algorithm corresponding to the encryption algorithm to obtain the plaintext of the transmitted message and store the same. At this point, the secure transmission of information is completed.

FIG. 2 is a flowchart of a quantum direct communication method according to an exemplary embodiment of the application. The communication method shown in FIG. 2 is applied to a sender of a quantum direct communication system. The communication method according to an exemplary embodiment of the application will be described in detail below with reference to FIG. 2.

As shown in FIG. 2, in S201, a transmitted message is encrypted by using an encryption algorithm to obtain a ciphertext corresponding to the transmitted message.

According to some embodiments, the encryption algorithm comprises a symmetric cipher, an asymmetric cipher and/or a post-quantum cipher.

In a specific embodiment, after encrypting the transmitted message in S201, the ciphertext corresponding to the transmitted message is sent to a quantum direct communication terminal of a sender, and S203 is executed.

In other embodiments, the quantum direct communication terminal of the sender comprises an encryption module, and in S201, the encryption module of the quantum direct communication terminal is used to encrypt the transmitted message.

In S203, the ciphertext is encoded into a quantum state through the quantum direct communication terminal of the sender according to a quantum communication protocol.

In a specific embodiment, S203 comprises:
firstly, precoding the ciphertext by the quantum direct communication terminal of the sender to obtain a transmitted codeword corresponding to the transmitted message; and
then, encoding the transmitted codeword corresponding to the ciphertext into the quantum state through the first quantum direct communication terminal according to the quantum communication protocol, and executing S205.

According to some embodiments, the precoding comprises error-correcting lossless coding, spread spectrum coding and/or secure coding. The quantum communication protocol comprises an entanglement protocol, a single photon protocol, a measurement device-independent protocol and/or a device-independent protocol.

In specific embodiments, different quantum communication protocols involve different methods of precoding. Generally, precoding comprises steps such as uniformizing original information, diluting the original information, and performing error-correcting coding and spread spectrum coding on the original information. Uniformizing the original information ensures that each bit of information transmitted after precoding is evenly distributed across the codewords after pre-coding. Diluting the original information involves introducing irrelevant information to reduce the proportion of the original information in the codewords after precoding. Error-correcting coding enables a receiver to detect and correct errors resulting from transmission after receiving the precoded original information. Error-correcting coding methods may involve Low-Density Parity-Check (LDPC) codes or Polar codes. Spread spectrum coding refers to mapping the error-corrected information into longer random number sequences or simply replicating it multiple times to include multiple pieces of the original information in the precoded original information.

In S205, the quantum state is sent to a receiver of a quantum direct communication system.

According to the embodiment shown in FIG. 1, before transmitting the transmitted message, the transmitted message is encrypted by using the encryption algorithm, which reduces the risk of messages being intercepted by eavesdroppers.

FIG. 3 is a flowchart of a quantum direct communication method according to an exemplary embodiment of the application. The communication method shown in FIG. 3 is applied to a receiver of a quantum direct communication system. The quantum direct communication method according to an exemplary embodiment of the application will be described in detail below with reference to FIG. 3.

As shown in FIG. 3, in S301, a quantum state sent from a sender is measured through a quantum direct communication terminal of the receiver to obtain a ciphertext corresponding to a transmitted message, the ciphertext being obtained by the sender encrypting the transmitted message using an encryption algorithm.

In a specific embodiment, S301 comprises:
firstly, measuring the quantum state sent from the sender by using the quantum direct communication terminal of the receiver to obtain a transmitted codeword corresponding to the ciphertext, the transmitted codeword being obtained by the sender precoding the ciphertext; and
then, decoding and/or decrypting the transmitted codeword according to a rule corresponding to the precoding to obtain the ciphertext, and executing S303.

In S303, decryption is performed by using a decryption algorithm corresponding to the encryption algorithm to obtain the transmitted message.

According to some embodiments, the quantum direct communication terminal of the receiver comprises a decryption module, and S303 may be realized by the decryption module of the quantum direct communication terminal.

According to other embodiments, after obtaining the ciphertext corresponding to the transmitted message in S301, the ciphertext is sent from the quantum direct communication terminal to the decryption module of the recipient, and S303 is executed to obtain the transmitted message.

According to the embodiment shown in FIG. 3, the transmitted message is decrypted based on the corresponding encryption algorithm employed during message transmission, so as to obtain the transmitted message and realize secure transmission of the transmitted message.

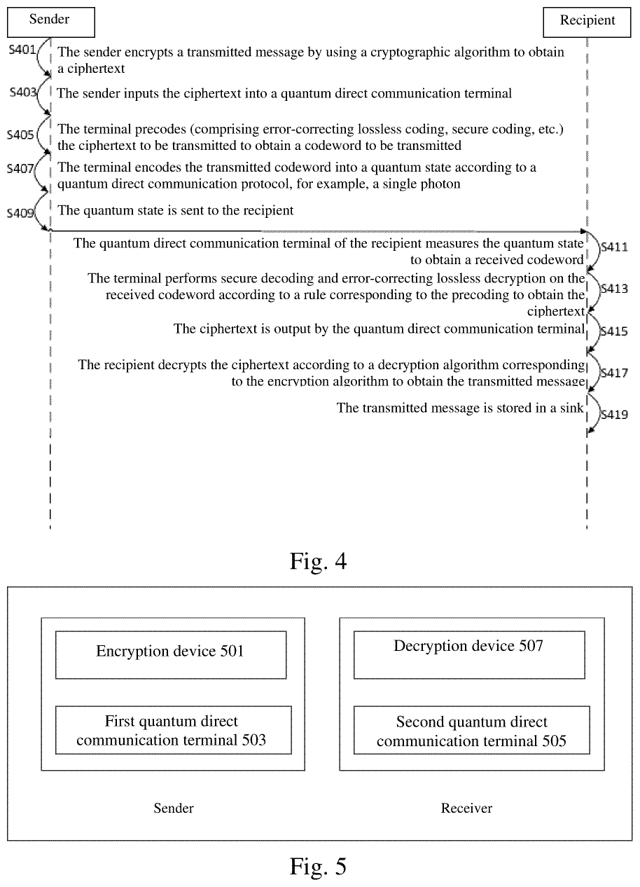

FIG. 4 is a communication timing diagram of quantum direct communication according to an exemplary embodiment of the application, and a quantum direct communication process according to an exemplary embodiment of the application will be described in detail below with reference to FIG. 4.

The quantum direct communication shown in FIG. 4 involves a sender and a recipient. When the sender needs to send a message to the recipient, the sender first performs the following steps.

In S401, the sender encrypts a transmitted message by using a cryptographic algorithm to obtain a ciphertext. For example, a symmetric cipher, an asymmetric cipher and/or a post-quantum cipher is used to encrypt the transmitted message.

In S403, the sender inputs the ciphertext into a quantum direct communication terminal of the receiver.

In S405, the quantum direct communication terminal precodes the ciphertext to be transmitted to obtain a codeword to be transmitted. Here, the precoding comprises error-correcting lossless coding, spread spectrum coding and/or secure coding.

In S407, the quantum direct communication terminal encodes the transmitted codeword into a quantum state according to a quantum direct communication protocol. For example, a single photon.

In S409, the quantum state is sent to the recipient.

At the recipient, after receiving the quantum state, the following steps are executed.

In S411, the quantum direct communication terminal of the receiver measures the quantum state to obtain a received codeword.

In S413, the quantum direct communication terminal decodes and/or decrypts the received codeword according to a rule corresponding to the precoding of the sender to obtain the ciphertext. Here, the decoding comprises spread spectrum decoding and/or decoding, and the decryption comprises error-correcting lossless decryption.

In S415, the ciphertext is output by the quantum direct communication terminal.

In S417, the receiver decrypts the ciphertext according to a decryption algorithm corresponding to the encryption algorithm to obtain the transmitted message.

In S419, the transmitted message is stored in a sink. At this point, the secure sending and receiving of the transmitted message are completed.

The embodiments of the application are introduced above mainly from the perspective of methods. Those skilled in the art should easily realize that the application can be implemented in hardware or a combination of hardware and computer software based on the operations or steps of various examples described in the embodiments disclosed herein. Those skilled in the art can implement the described functions in different ways for each specific operation or method, and such implementation should not be considered beyond the scope of this application.

An apparatus embodiment of the application is described below. For details not disclosed in the apparatus embodiment of the application, please refer to the method embodiment of the application.

FIG. 5 is a block diagram of a quantum direct communication system according to an exemplary embodiment of the application. The quantum direct communication system shown in FIG. 5 comprises a sender and a recipient. The sender comprises an encryption device 501 and a first quantum direct communication terminal 503. The receiver comprises a second quantum direct communication terminal 505 and a decryption device 507.

According to some embodiments, the encryption device 501 is configured to encrypt a transmitted message by using an encryption algorithm to obtain a ciphertext corresponding to the transmitted message, and the first quantum direct communication terminal of the sender 503 is configured to encode the ciphertext into a quantum state according to a quantum communication protocol and send the quantum state to the receiver of the quantum direct communication system. The second quantum direct communication terminal of the receiver 505 is configured to measure a quantum state sent from the sender to obtain a ciphertext corresponding to the transmitted message, the ciphertext being obtained by the sender encrypting the transmitted message by using an encryption algorithm, and the decryption device 507 is configured to perform decryption by using a decryption algorithm corresponding to the encryption algorithm used by the sender to obtain the transmitted message.

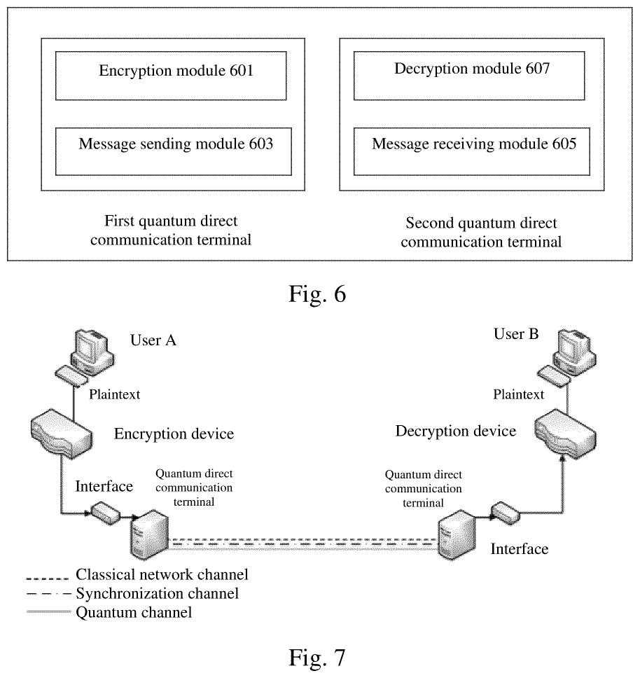

FIG. 6 is a block diagram of another quantum direct communication system according to an exemplary embodiment of the application. The quantum direct communication system shown in FIG. 6 comprises a first quantum direct communication terminal and a second quantum direct communication terminal. The first quantum direct communication terminal comprises an encryption module 601 and a message sending module 603. The second quantum direct communication terminal comprises a message receiving module 605 and a decryption module 607. The encryption module 601 is configured to encrypt a transmitted message by using an encryption algorithm to obtain a ciphertext corresponding to the transmitted message, the message sending module 603 is configured to encode the ciphertext into a quantum state according to a quantum communication protocol and send the quantum state to the second quantum direct communication terminal, the message receiving module 605 is configured to measure the quantum state sent from the first quantum direct communication terminal to obtain a ciphertext corresponding to the transmitted message, the ciphertext being obtained by the first quantum direct communication terminal encrypting the transmitted message by using the encryption algorithm, and the decryption module 607 is configured to perform decryption by using a decryption algorithm corresponding to the encryption algorithm to obtain the transmitted message.

FIG. 7 is a schematic diagram of a quantum direct communication system according to an exemplary embodiment of the application. As shown in FIG. 7, a quantum direct communication terminal connects to a communication network by replacing existing optical communication terminals or through additional deployments. Two quantum direct communication terminals are connected via two optical fiber channels, namely a quantum channel and a synchronization channel, as well as a classical network channel, which are used for transmitting quantum states, synchronizing the electronics of both parties, and transmitting publicly available information respectively.

According to some embodiments, the communicating parties may also employ a shared fiber transmission technique, meaning that quantum state transmission, synchronization signal transmission, and public information exchange can all be completed through a single optical fiber channel.

As shown in FIG. 7, user A encrypts plaintext information to be transmitted by an encryption device to obtain a ciphertext data stream. The ciphertext data stream enters the quantum direct communication terminal through the illustrated interface, which may connect the encryption device with the quantum direct communication terminal. The quantum direct communication terminal takes quantum state as the information carrier and transmits the ciphertext to a receiver through the quantum channel. The receiver inputs the received ciphertext data stream into a decryption device through the interface shown in the figure. After the decryption device decrypts the ciphertext, user B will get the plaintext information.

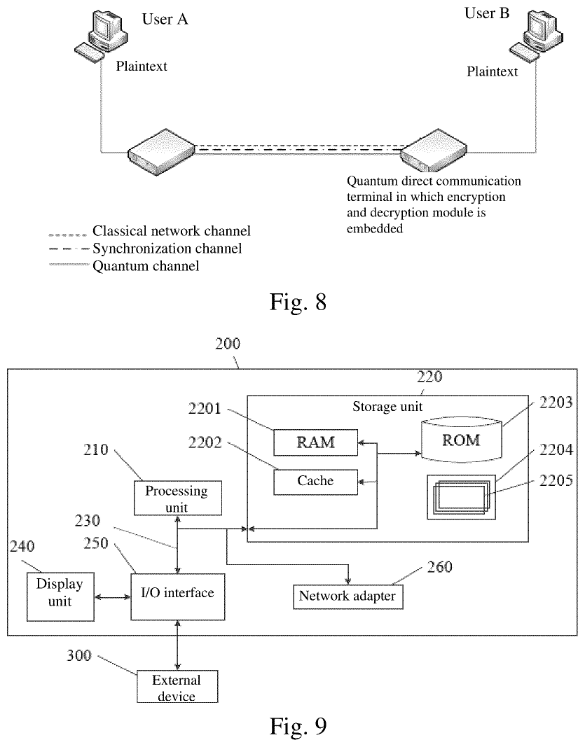

According to other embodiments of the application, at the sender, an encryption and decryption module may be embedded in the quantum direct communication terminal, as shown in FIG. 8. The encryption and decryption module of the quantum direct communication terminal at the sender is used to encrypt and decrypt information. For example, after the sender inputs transmitted information into the quantum direct communication terminal, the transmitted information is encrypted by the encryption and decryption module embedded in the quantum direct communication terminal to form a ciphertext, and the ciphertext is sent to the receiver through a quantum direct communication function module.

Accordingly, at the recipient, an encryption and decryption module may be embedded in the quantum direct communication terminal. As shown in FIG. 8, after receiving the ciphertext, the quantum direct communication function module decrypts the ciphertext by using the embedded encryption and decryption module, so as to obtain the transmitted plaintext and output it to the information recipient.

FIG. 9 shows an electronic device according to an exemplary embodiment of the application. An electronic device 200 according to this embodiment of the application will be described below with reference to FIG. 9. The electronic device 200 shown in FIG. 9 is only an example, and should not impose any restrictions on the functions and application scope of the embodiment of the application.

As shown in FIG. 9, the electronic device 200 is represented in the form of a general-purpose computing device. Components of the electronic device 200 may include, but are not limited to, at least one processing unit 210, at least one storage unit 220, a bus 230 connecting different system components (including the storage unit 220 and the processing unit 210), a display unit 240, etc.

The storage unit stores a program code, and the program code can be executed by the processing unit 210, so that the processing unit 210 performs the methods described in this specification according to various exemplary embodiments of the application. For example, the processing unit 210 may perform the method as shown in FIG. 1.

The storage unit 220 may comprise a readable medium in the form of a volatile storage unit, such as a random access memory (RAM) 2201 and/or a cache storage unit 2202, and may further comprise a read-only memory (ROM) 2203.

The storage unit 220 may also comprise a program/utility tool 2204 with a group of (at least one) program modules 2205, such program modules 2205 include but are not limited to: an operation system, one or more application programs, other program modules and program data, and each or some combination of these examples may include the implementation of a network environment.

The bus 230 may represent or more of several types of bus structures, including memory cell bus or memory cell controller, peripheral bus, graphics acceleration port, processing unit or local bus using any of a variety of bus structures.

The electronic device 200 can also communicate with one or more external devices 300 (e.g., keyboard, pointing device, Bluetooth device, etc.), with one or more devices that enable users to interact with the electronic device 200, and/or with any device that enables the electronic device 200 to communicate with one or more other computing devices (e.g., routers, modems, etc.). This communication can be performed through an input/output (I/O) interface 250. Further, the electronic device 200 can also communicate with one or more networks (such as a local area network (LAN), a wide area network (WAN) and/or a public network, such as the Internet) through a network adapter 260. The network adapter 260 can communicate with other modules of the electronic device 200 through a bus 230. It should be understood that although not shown in the figure, other hardware and/or software modules can be used in conjunction with the electronic device 200, including but not limited to microcodes, device drivers, redundant processing units, external disk drive arrays, RAID systems, tape drives, data backup storage systems, etc.

Through the description of the above embodiments, it is easy for those skilled in the art to understand that the exemplary embodiments described here can be realized by software or by combining software with necessary hardware. The technical solutions according to the embodiments of the application may be embodied in the form of a software product, which may be stored in a non-volatile storage medium (which may be a CD-ROM, USB flash drive, mobile hard drive, etc.) or on a network, and may include several instructions to enable a computing device (which may be a personal computer, server, or network device, etc.) to execute the method according to the embodiments of the application.

A software product can adopt any combination of one or more readable media. The readable medium may be a readable signal medium or a readable storage medium. The readable storage medium can be, for example, but is not limited to, an electrical, magnetic, optical, electromagnetic, infrared, or semiconductor system, apparatus or device, or a combination of any of the above. More specific examples (a non-exhaustive list) of readable storage media include: electrical connection with one or more wires, a portable disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above.

The computer-readable storage medium may be a data signal propagated in a baseband or as part of a carrier wave, in which a readable program code is contained. This propagated data signal can take many forms, including but not limited to electromagnetic signal, optical signal or any suitable combination of the above. The readable storage medium may also be any readable medium other than the readable storage medium, which can send, propagate or transmit a program for use by or in combination with an instruction execution system, apparatus or device. The program code contained in the readable storage medium can be transmitted by any suitable medium, including but not limited to Wi-Fi, wire, optical cable, RF, etc., or any suitable combination of the above.

Computer program codes for performing the operations of the disclosure can be written by a combination of one or more programming languages, including object-oriented programming languages such as Java, C++, and conventional procedural programming languages such as “C” language or similar programming languages. The program code can be completely executed on user computing equipment, partially executed on user equipment, executed as an independent software package, partially executed on user computing equipment and partially executed on remote computing equipment, or completely executed on remote computing equipment or a server. In a case involving remote computing equipment, the remote computing equipment may be connected to user computing equipment through any kind of network including a local area network (LAN) or a wide area network (WAN), or may be connected to external computing equipment (e.g., connected through the Internet using an Internet service provider).

The said computer-readable medium carries one or more programs, which, when executed by the said equipment, cause the computer-readable medium to realize the aforementioned functions.

Those skilled in the art can understand that the above modules can be distributed in devices according to the description of the embodiment, or can be uniquely arranged in one or more devices of this embodiment with corresponding changes. The modules in the above embodiments can be merged into one module or further split into multiple submodules.

According to an embodiment of the application, a computer program product is provided, comprising computer programs or instructions, and the computer programs or instructions, when executed by a processor, may implement the above method.

The embodiments of the application have been introduced in detail above. Specific examples are applied herein to illustrate the principle and implementation of the application. The above embodiments are only used to help understand the method of the application and its core ideas. The changes or deformations made by those skilled in the art based on the ideas of the application and the specific implementation and application scope of the application are within the scope of protection of the application. To sum up, the content of this specification should not be construed as a limitation of the application.

1-12. (canceled)

13. A communication method for quantum direct communication, applied to a sender of a quantum direct communication system, comprising:
encrypting a transmitted message using an encryption algorithm to obtain a ciphertext corresponding to the transmitted message;
encoding the ciphertext into a quantum state through a quantum direct communication terminal of the sender according to a quantum communication protocol; and
sending the quantum state to a receiver of the quantum direct communication system.

14. The communication method according to claim 13, wherein the encryption algorithm comprises a symmetric cipher, an asymmetric cipher and/or a post-quantum cipher.

15. The communication method according to claim 14, before encoding the ciphertext into a quantum state through a first quantum direct communication terminal according to a quantum communication protocol, further comprising:
precoding the ciphertext to obtain a transmitted codeword corresponding to the transmitted message.

16. The communication method according to claim 15, wherein the precoding comprises error-correcting lossless coding, spread spectrum coding and/or secure coding.

17. The communication method according to claim 15, wherein encoding the ciphertext into a quantum state through a first quantum direct communication terminal according to a quantum communication protocol comprises:
encoding the transmitted codeword corresponding to the ciphertext into the quantum state through the first quantum direct communication terminal according to the quantum communication protocol.

18. The communication method according to claim 13, wherein the quantum communication protocol comprises an entanglement protocol, a single photon protocol, a measurement device-independent protocol and/or a device-independent protocol.

19. A communication method for a quantum secure direct communication, applied to a receiver of a quantum direct communication system, comprising:
measuring a quantum state sent from a sender through a quantum direct communication terminal of the receiver to obtain a ciphertext corresponding to a transmitted message, the ciphertext being obtained by the sender encrypting the transmitted message by using an encryption algorithm; and
performing decryption using a decryption algorithm corresponding to the encryption algorithm to obtain the transmitted message.

20. The communication method according to claim 19, wherein measuring a quantum state sent from a sender through a quantum direct communication terminal of the receiver to obtain a ciphertext corresponding to a transmitted message comprises:
measuring the quantum state sent from the sender using the quantum direct communication terminal of the receiver to obtain a transmitted codeword corresponding to the ciphertext, the transmitted codeword being obtained by the sender precoding the ciphertext; and
decoding and/or decrypting the transmitted codeword according to a rule corresponding to the precoding to obtain the ciphertext.

21. A quantum direct communication system, comprising a sender and a receiver, wherein the sender comprises:
an encryption device configured to encrypt a transmitted message using an encryption algorithm to obtain a ciphertext corresponding to the transmitted message; and
a first quantum direct communication terminal configured to encode the ciphertext into a quantum state according to a quantum communication protocol and send the quantum state to the receiver of the quantum direct communication system; and
the receiver comprises:
a second quantum direct communication terminal configured to measure a quantum state sent from the sender to obtain a ciphertext corresponding to the transmitted message, the ciphertext being obtained by the sender encrypting the transmitted message using an encryption algorithm;
a decryption device configured to perform decryption using a decryption algorithm corresponding to the encryption algorithm to obtain the transmitted message.

22. A quantum direct communication system, comprising a first quantum direct communication terminal and a second quantum direct communication terminal, wherein
the first quantum direct communication terminal comprises an encryption module and a message sending module,
the encryption module is configured to encrypt a transmitted message using an encryption algorithm to obtain a ciphertext corresponding to the transmitted message,
the message sending module is configured to encode the ciphertext into a quantum state according to a quantum communication protocol and send the quantum state to the second quantum direct communication terminal,
the second quantum secure direct communication terminal comprises a message receiving module and a decryption module,
the message receiving module is configured to measure the quantum state sent from the first quantum secure direct communication terminal to obtain a ciphertext corresponding to the transmitted message, the ciphertext being obtained by the encryption module of the first quantum direct communication terminal encrypting the transmitted message using the encryption algorithm, and
the decryption module is configured to perform decryption using a decryption algorithm corresponding to the encryption algorithm to obtain the transmitted message.

23. An electronic device, comprising a memory and a processor, wherein the memory stores one or more computer instructions, and the one or more computer instructions, when executed by the processor, implement the communication method according to claim 13.

24. A non-transitory computer-readable storage medium, wherein a computer program is stored thereon, and when the computer program is executed, the communication method according to claim 13 is implemented.
